(19) United States
(12) Patent Application Publication
(10) Pub. No.: US 2009/0026295 A1
(43) Pub. Date: Jan. 29, 2009

(54) Cutting assembly having at least one perforated or cutting plate with through channels

(76) Inventors: Dirk Mathiebe, Verden (DE); Heiko Walther, Reer (DE)

Correspondence Address: COLLARD & ROE, P.C., 1077 NORTHERN BOULEVARD, ROSLYN, NY, 11576, US

(21) Appl. No.: 12/218,699

(22) Filed: Jul. 17, 2008

(30) Foreign Application Priority Data
Jul. 18, 2007 (DE) 20 2007 010 087.6

(51) Int. Cl. B02C 18/36

(52) U.S. Cl. 241/82.5

(57) ABSTRACT

In the case of a cutting assembly having at least one perforated or cutting plate which has through channels and having at least one cutting knife which is assigned to the perforated or cutting plate, the cutting knife being connected with a rotatable shaft in a rotationally fixed manner, it is provided that the perforated or cutting plate exhibits through channels at its centre and distributed over its entire extent.

Meat products or other products which must have a constant consistency over their entire extent with regard to the product mass can be produced with a cutting assembly of this type.

The invention relates to a cutting assembly having at least one perforated or cutting plate which has through channels and having at least one cutting knife which is assigned to the perforated or cutting plate, the cutting knife being connected to a rotatable shaft in a rotationally fixed manner.

Cutting assemblies of the generic type mentioned at the start are used for the grinding of meat products, milk products or other foods. For example, meat is pressed, with pressure, into the perforated or cutting plate which exhibits through channels and during this pressing in, portions of meat are cut off with the cutting knife. The cutting knife is assigned to the perforated or cutting plate in this case and is located in direct proximity to the inlets of the through channels on one side of the perforated or cutting plate.

Bits of meat that are pressed through a perforated or cutting plate of a cutting assembly are often processed further directly after having been pressed through. They can be used as burgers, in that these pieces of meat, e.g. meat patties are packaged, flash frozen or even cooked directly after mincing.

The disadvantage that arises in the case of this direct processing of minced meat is that a depression in the meat mass is to be observed in the central region of this meat product. A depression or dent is produced. The cause of this depression or dent is a lack of meat in the centre of the meat product, which is caused by the construction of known cutting assemblies.

In the case of known cutting assemblies, the shaft for the cutting knife is passed through the perforated or cutting plate and/or accommodated by this in such a manner that no through channels are arranged in the centre of the perforated or cutting plate. The centre of known perforated or cutting plates in each case exhibits a region which is required from a structural point of view to accommodate the shaft and/or the knife hub. As a result, the shaft is admittedly guided securely, however, meat only exits from the perforated or cutting plate annularly, as, without through channels, meat cannot leave the perforated or cutting plate through the centre. The meat is then reassembled with the aid of funnel devices and the absence of meat that has passed through in the centre of the perforated or cutting plate is concealed as well as possible, however, this lack of meat is particularly recognizable in the case of direct further processing of the meat products.

Additionally, in the prior art no cutting knives are available which have knife blades which can be guided over the centre of the perforated or cutting plate. In the prior art, the cutting knives are located on the shaft and the shaft is passed through the cutting knives. The cutting knives therefore have openings for the shaft at their centre, so that no knife blades can be arranged in the centre.

The object of the invention is to show a cutting assembly of the generic type mentioned at the start, using which, meat products or other products which must have a constant consistency over their entire extent, particularly with regard to the product mass, can be produced.

This object is achieved according to a first alternative and in accordance with the invention in that the perforated or cutting plate exhibits through channels at its centre and distributed over its entire extent.

The perforated or cutting plate according to the invention does not have a closed region at its centre. Rather, there are through channels present there, which allow meat to pass through the perforated or cutting plate. As these through channels are distributed over the entire perforated or cutting plate, a uniform throughput of meat is guaranteed across the entire perforated or cutting plate. Meat products leaving this perforated or cuffing plate exhibit a constant consistency and can readily be processed further to burger patties and similar products. The creation of dents in the respective centre region of such a meat product is advantageously prevented.

The distance between adjacent through channels can be the same in each case. However, it can also be provided that the distance between adjacent through channels in the centre of the perforated or cutting plate is smaller than in outer regions of the perforated or cutting plate. If, for example, the situation arises that supplying meat to the centre region is somewhat difficult, an increased number of through channels can be arranged in the centre of the perforated or cutting plate if the space between the through channels is reduced. These through channels create a cross section, in the case of which enough meat passes through the perforated or cutting plate.

The cutting assembly has a housing through which the the meat is pressed. As is generally known, the perforated or cutting plate closes off the entire cross section of this housing and the perforated or cutting plate has suitable devices for fixing it in the housing.

According to an alternative solution of the object, for which protection is of course claimed, it is provided that the cutting knife has at least one blade, the sections of which stretch to the rotational axis of the shaft.

In the case of the cutting knife of the cutting assembly according to the invention, the shaft is not passed through the cutting knife. As a result, it is possible to arrange sections of a blade in the region of the rotational axis of the shaft, preferably to allow the blade to cross completely through the rotational axis of the shaft. This cutting knife can be assigned to the perforated or cutting plate with through channels distributed across its entire extent. The blade is dimensioned in such a manner that it covers all regions of the perforated or cutting plate, particularly in its centre. The blade can have an indentation in the region of the rotational axis of the shaft, so that e.g. two blade sections are formed. Preferably, the cutting knife exhibits at least one blade that runs through the rotational axis of the shaft.

A development of the invention provides that the blade has an overall height of approximately 10 mm to approximately 30 mm. The blade rests directly on the surface of the perforated or cutting plate which exhibits the through channels. With the overall height of approximately 10 mm to 30 mm, the cutting knife creates a space 10 mm to 30 mm high, which is kept free of other components of the cutting assembly. As a result, however, a space is advantageously produced, in which the e.g. meat fed to the perforated or cutting plate can distribute itself evenly. This even distribution then ensures an even entrance of the meat into the perforated or cutting plate.

For a further configuration of the invention, it is provided that the cutting knife exhibits a blind hole for accommodating the shaft. So the cutting knife does not have a continuous bore for accommodating the shaft. The shaft can be inserted on one side into the blind hole, it does not emerge on the other side of the cutting knife. This allows a blade to be passed through the rotational axis of the shaft.

A further solution of the above-mentioned object, for which, protection is of course claimed, is characterized in that the cutting assembly exhibits a perforated or cutting plate according to the inventive features specified above and a cutting knife according to the inventive features mentioned above. The interaction of both components has already been described above.

Exemplary embodiments of the invention, from which further inventive features result, are represented in the drawing. In the figures:

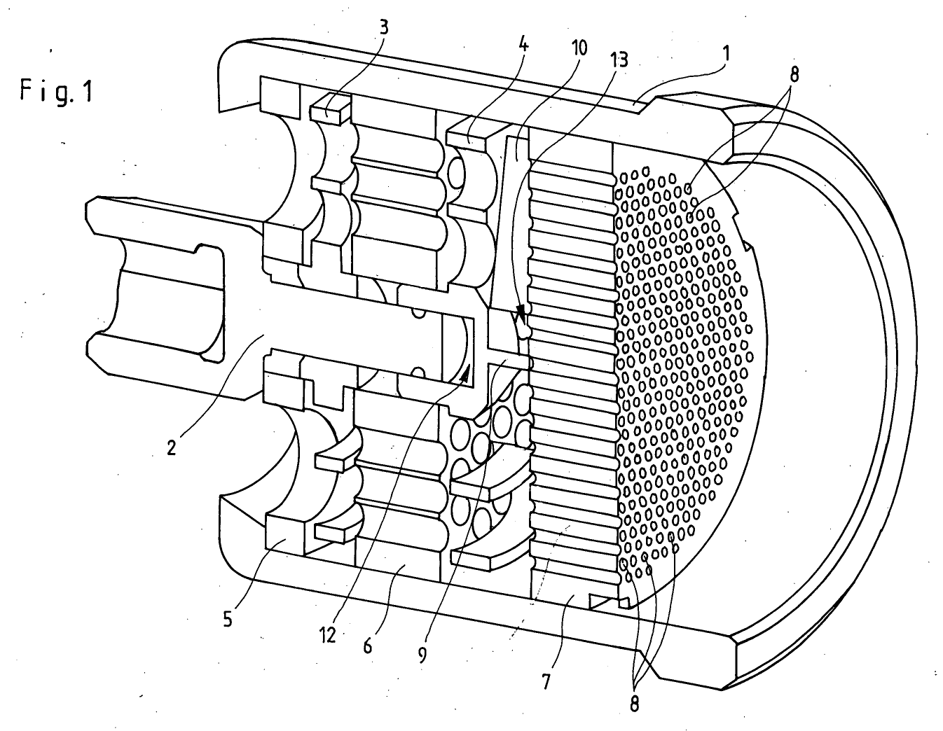

FIG. 1: shows a perspective side view of a cutting assembly according to the invention,

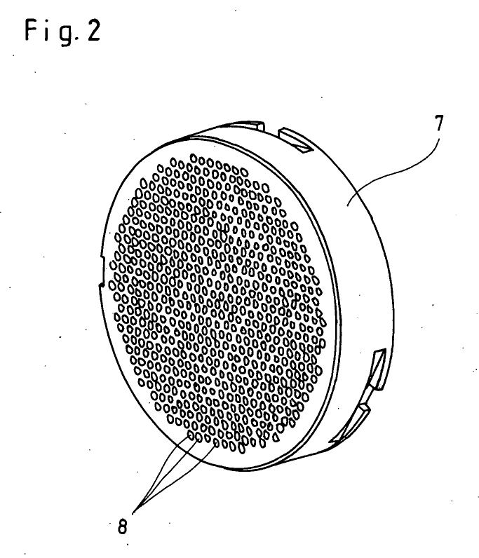

FIG. 2: shows a perspective view of a component of the cutting assembly according to FIG. 1, and

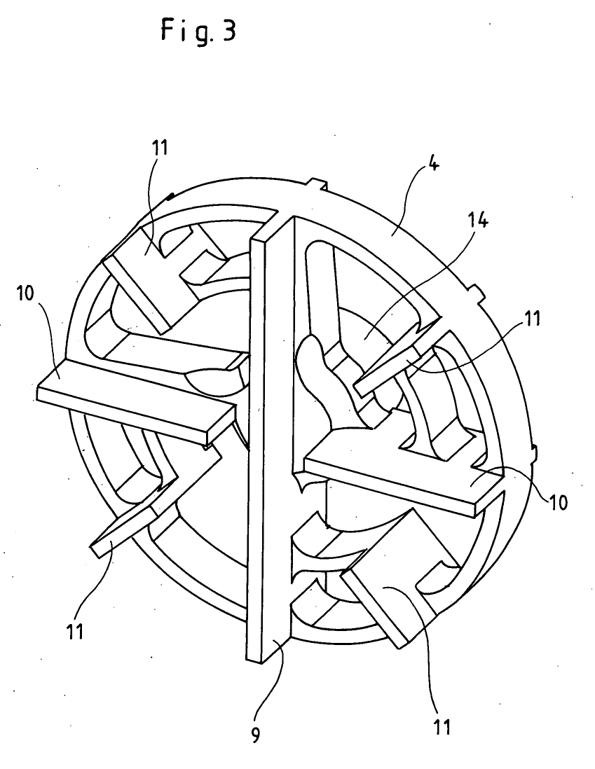

FIG. 3: shows a perspective view of a further component of the cutting assembly according to FIG. 1.

The cutting assembly in FIG. 1 exhibits a cylindrical housing 1. A shaft 2, to which two cutting knives 3, 4 are connected in a rotationally fixed manner, runs through this housing 1. Furthermore a precutter 5, a cutting plate 6 and a perforated plate 7 are arranged in a rotationally fixed manner in the housing 1. Through channels are arranged in the precutter 5 and in the perforated or cutting plates 6, 7, through which channels meat introduced into the housing 1 of the cutting assembly can be pressed. During this pressing in, the meat is cut again and again by the cutting knives 3, 4 which rotate due to a turning of the shaft 2. The cutting knives 3, 4 stretch across the entire cross section of the housing 1 in each case.

The perforated plate 7 is, according to the invention, provided with through channels 8 at its centre and over its entire extent. In contrast, the shaft 2 does not come into contact with the perforated plate 7.

The cutting knife 4 which is assigned directly to the perforated plate 7 exhibits, according to the invention, a blade 9 which passes through the rotational axis of the shaft 2. This blade 9 sweeps over the through channels 8 of the perforated plate 7, it can cut meat entering into the through channels 8, particularly in the centre region of the perforated plate 7. The cutting knife 4 carries further blades 10, 11.

A blind hole 12 is made in the cutting knife 4, into which the shaft 2 protrudes. The shaft 2 does not pass through the cutting knife 4.

The blade 9 and the further blades 10, 11 exhibit a relatively large overall height of e.g. 15 mm. As a result of this overall height, a space 13 is formed upstream of the perforated plate 7 in the direction of travel of the meat, which space allows an even distribution of meat which has already passed through the precutter 5 and the cutting plate 6.

FIG. 2 once again shows the uniform distribution of the through channels 8 over the entire extent of the perforated plate 7. In a configuration of the perforated plate 7 as a cutting plate, which configuration is not shown, a larger opening can be included, if appropriate, to allow cartilage and other constituents to be carried away. However, the centre of this cutting plate is, in any event, covered with through channels 8.

FIG. 3 shows the cutting knife 4. It is of radially symmetrical configuration and exhibits a knife hub 14 for the blind hole 12. The blades 9, 10, 11 are arranged on the opposite side to the blind hole 12. The blade 9 stretches across the entire diameter of the cutting knife 4. It passes through the rotational axis of the shaft 2.

1. Cutting assembly having at least one perforated or cutting plate which has through channels and having at least one cutting knife which is assigned to the perforated or cutting plate, the cutting knife being connected with a rotatable shaft in a rotationally fixed manner, wherein the perforated or cutting plate (7) exhibits through channels (8) at its center and distributed over its entire extent.

2. Cutting assembly according to claim 1, wherein the distance between adjacent through channels (8) is the same in each case.

3. Cutting assembly according to claim 1, wherein the distance between adjacent through channels (8) in the center of the perforated or cutting plate (7) is smaller than in outer regions of the perforated or cutting plate (7).

4. Cutting assembly according to claim 1, wherein the perforated or cutting plate (7) has devices for fixing it into a housing (1).

5. Cutting assembly having at least one perforated or cutting plate which has through channels and having at least one cutting knife which is assigned to the perforated or cutting plate, the cutting knife being connected with a rotatable shaft in a rotationally fixed manner, wherein the cutting knife (4) has at least one blade (9), the sections of which stretch to the rotational axis of the shaft (2).

6. Cutting assembly according to claim 5, wherein the cutting knife (4) exhibits at least one blade (9) that runs through the rotational axis of the shaft (2).

7. Cutting assembly according to claim 5, wherein the blade (9) has an overall height of approximately 10 mm to approximately 30 mm.

8. Cutting assembly according to claim 5, wherein the cutting knife (14) exhibits a blind hole (12) for accommodating the shaft (2).

9. Cutting assembly having at least one perforated or cutting plate which has through channels and having at least one cutting knife which is assigned to the perforated or cutting plate, the cutting knife being connected with a rotatable shaft in a rotationally fixed manner, wherein the perforated or cutting plate (7) is configured according to claim 1 and the cutting knife (4) has at least one blade (9), the sections of which stretch to the rotational axis of the shaft (2).
